(19) United States
(12) Patent Application Publication
(10) Pub. No.: US 2013/0099927 A1
(43) Pub. Date: Apr. 25, 2013

(54) ASSETS AND PERSONNEL TRACKING USING RADIO FREQUENCY IDENTIFICATION

(71) Applicants: Joseph M. Kulinets, Melrose, MA (US); Peter R. Nuytkens, Melrose, MA (US); Arvind K. Venkatesh, (US)

(72) Inventors: Joseph M. Kulinets, Melrose, MA (US); Peter R. Nuytkens, Melrose, MA (US); Arvind K. Venkatesh, (US)

(73) Assignee: Q Developments, LLC, Melrose, MA (US)

(21) Appl. No.: 13/474,030

(22) Filed: May 17, 2012

Related U.S. Application Data
(63) Continuation of application No. PCT/US10/57079, filed on Nov. 17, 2010.
(60) Provisional application No. 61/262,083, filed on Nov. 17, 2009.

(51) Int. Cl. G08B 13/24

(52) U.S. Cl. CPC G08B 13/2462
USPC 340/572.1

(57) ABSTRACT

A system for updating a location of a target with an RFID device in response to detected motion of the target includes a server and tracking modules. The server stores identifying information for RFID devices and locations associated with the devices. The tracking modules are positioned in predetermined locations and communicate with the server. Each tracking module includes a motion processing module and an RFID reader. In response to motion detected by a motion processing module, the RFID reader detects identifying information for an RFID device neighboring an RFID reader and transmits the information to the server.

### RELATED APPLICATION

The present application claims priority to U.S. Patent Application No. 61/262,083, entitled “Assets and Personnel Tracking Using Radio Frequency Identification” and filed on Nov. 17, 2009, which is incorporated herein by reference in its entirety.

### BACKGROUND

The present disclosure relates generally to tracking systems using radio frequency identification (RFID). In particular, the present disclosure is directed to active tracking systems using RFID to keep and manage knowledge of a position of particular device.

### SUMMARY

The present disclosure is directed to systems and methods for monitoring a location of a target associated with an RFID device. When a tracking modules detects motion of the RFID device across a passage node, an RFID reading system detects the RFID devices within a particular range. The RFID reading system uses the identity of the RFID device and information about the direction of the detected motion to enable a central server to update the location of the RFID devices.

In one aspect, the present disclosure is directed to a tracking system for updating a location of a target associated with an RFID device in response to detected motion of the target. The system includes a server for storing identifying information for at least one RFID device and a location associated with the RFID device. The system also includes a plurality of tracking modules positioned in predetermined locations and in communication with the server, each tracking module comprising at least one motion processing module and an RFID reader. In response to motion detected by the at least one motion processing module, the RFID reader detects identifying information associated with the RFID device neighboring the RFID reader and transmits the detected identifying information to the server.

The identifying information can be a serial number associated with the RFID device. The server can update the location associated with the RFID device according to an identity of the RFID reader that transmits the detected identifying information. The RFID reader can transmit a location of the RFID reader to the server in conjunction with the detected identifying information of the RFID device. The target can be an asset or a person.

Each motion processing module can include at least two directional motion sensors and a motion detector. The motion detector can analyze signals received from the at least two directional motion sensors to select at least one directional RFID antenna for detecting the neighboring RFID devices. The motion detector can determine a direction and a distance of motion from the received signals and select the directional RFID antenna for detecting the neighboring RFID devices according to the direction and the distance. The RFID reader can use the determined direction and distance of motion to use at least one particular directional RFID antenna. The RFID reader can include a microcontroller in communication with the at least one motion processing module. The microcontroller can initiate detection of the identifying information by the RFID reader in response to motion detected by the at least one motion processing module.

The RFID device can be a wristband, a badge, or a card. The server can update the location associated with the RFID device in response to transmitted identifying information associated with the RFID device.

In another aspect, the present disclosure is directed to a method for updating a location of a target associated with an RFID device in response to detected motion of the target, the method comprising. The method includes detecting, by a motion processing module of an RFID reader, motion. The method also includes detecting, by the RFID reader in response to the motion, identifying information associated with an RFID device neighboring the RFID reader. The method also includes transmitting, by the RFID reader, the identifying information to the server. The method also includes updating, by the server, a location of the RFID device according to the identifying information of the RFID device and an identity of the RFID reader.

The method can also include transmitting, by the RFID reader, a location of the neighboring RFID reader to the server. Detecting motion can include analyzing, by a motion detector of the motion processing module, signals received from at least two directional motion sensors. Detecting motion can include selecting, by the motion detector, at least one directional RFID antenna for detecting the neighboring RFID device. Detecting motion can include determining, by the motion detector, a direction and a distance of motion from the received signals, and selecting, by the RFID reader, a directional RFID antenna for detecting the neighboring RFID device according to the direction and the distance.

### BRIEF DESCRIPTION OF THE DRAWINGS

The features of the presently disclosed tracking system and method will be described with reference to the figures, wherein:

FIG. 1 is an exemplary block diagram of an asset and personnel tracking system using RFID;

FIG. 2 is an exemplary block diagram of a tracking module used in the asset and personnel tracking system;

FIGS. 3A-3C depicts RFID devices used with the asset and personnel tracking system;

FIGS. 4A and 4B depict two possible installations of a motion processing module of a tracking module over a doorway, wherein sets of antennae and motion sensors are placed on the same or opposite sides of the doorway;

FIGS. 5A, 5B, 6A, 6B, and 7A depict possible installations of motion processing modules over doorways, wherein sets of antennae and motion sensors are placed on opposite sides of the doorway;

FIGS. 7B and 7C depict possible installations of motion processing modules over doorways, wherein sets of antennae and motion sensors are placed on the same side of the doorway;

FIG. 8 is an exemplary block diagram of a tracking module with motion processing modules spanning multiple locations; and

FIG. 9 is an exemplary block diagram of tracking modules installed in a hospital.

### DETAILED DESCRIPTION

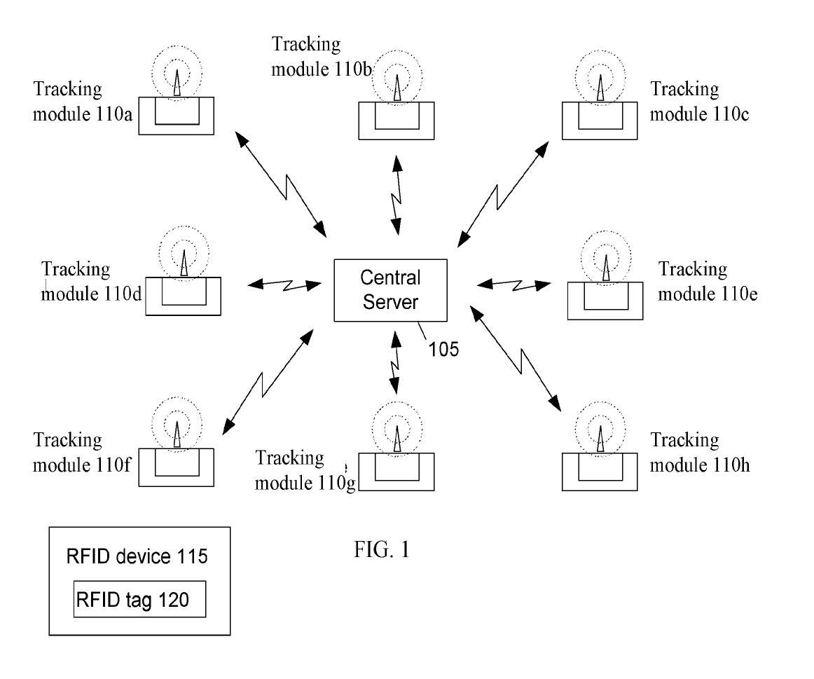

Referring to FIG. 1, a block diagram of an asset and personnel tracking system 100 using RFID is shown and described. The system includes a central server 105 in communication with tracking modules 110a, 110b, . . . , 110h (collectively, “110”). The tracking modules 110 are positioned at various passage nodes (also referred to herein as “choke points”) in a facility, such as a hospital or warehouse. The central server 105 monitors the location of targets within the facility. When a tracking module 110 detects movement at a passage node, the tracking module 110 detects and identifies targets within its range and transmits the identity of such targets to the central server 105. In response, the central server 105 stores the updated locations of targets.

A target can be an asset or a person. When a target first enters the facility, the target can receive an RFID device 115 having an RFID tag 120 storing identifying information, such as, for example, a serial number. The central server 105 stores the target's RFID tag 120 and initial position in the facility. The assets can receive RFID devices 115 when the assets are being inventoried. People can receive RFID devices 115 prior to entering the facility. The RFID device 115 can be a badge, wristband, or card that incorporates the RFID tag 120.

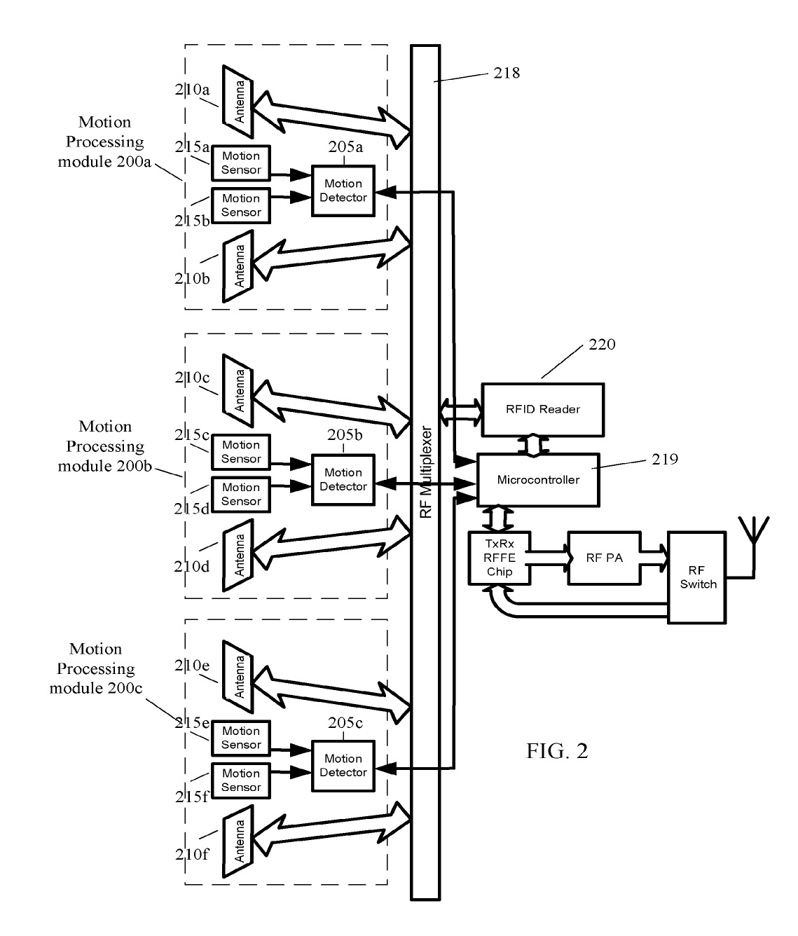

Referring to FIG. 2, a block diagram of a tracking module 110 used in the asset and personnel tracking system 100 is shown and described. The tracking module 110 includes at least one motion processing module 200, each module 200 having a motion detector 205, at least two antennae 210a, 210b (e.g., directional antenna), and at least two motion sensors 215a, 215b. When the motion sensors 215 sense motion, the sensors 215 transmit signals regarding the motion to the motion detector 205. The motion detector 205 communicates with the microcontroller 219 to activate the RFID reader 220. In response, the RFID reader 220 delivers power to an antenna 210 proximate to the motion sensors 215. Accordingly, the antenna 210 broadcasts power via RF waves to RFID devices 115 within the antenna's 210 range. The broadcasted RF waves power such RFID devices 115, which then transmit their identifying information to the antenna 210. The RFID reader 220 delivers identifying information of detected RFID devices 115 to the central server 105. In response, the central server 105 updates the location of targets associated with the detected RFID devices 115.

In further detail, the motion sensors 215 can be passive infrared (PIR) sensors. In some embodiments, the motion sensors 215 can be directional motion sensors. In these embodiments, the motion detector 205 can analyze signals from such motion sensors 215 to determine the direction of motion. The motion detector 205 can also determine the distance of motion. Based on the direction and/or distance of motion, the motion detector 205 can select an antenna 210 that the RFID reader 220 should power to detect RFID devices 115. In some embodiments, the motion detector 205 selects the antenna 210 in the exit direction of the moving target. In many embodiments, the motion detector 205 can select more than one antenna 210 in the direction of the moving target to be powered. In some embodiments, the motion detector 205 transmits the direction of motion with the identifying information of the RFID device 115 to the central server 105.

Additionally, the central server 105 can update the locations of targets according to numerous methods. In some embodiments, the central server 105 can store the locations of the RFID readers 220. When the central server 105 receives identifying information of an RFID device 115 from an RFID reader 220, the central server 105 can identify the RFID reader 220 and update the location of the RFID device's 115 target according to the stored location of the reader 220.

When a tracking modules 110 spans multiple rooms and/or hallways of the facility, the central server 105 can store the locations of the module's antennae 210. In these embodiments, the RFID reader 220 can transmit the identity of the antenna 210 that detects the RFID device 115 with the detected device's identifying information. When the central server 105 receives the antenna's 210 identity, the server 105 updates the location of the target associated with the RFID device 115 according to the antenna's 210 location.

In some embodiments, the central server 105 can update the location of a target according to the identity of the RFID reader 220 and/or the antenna 210 that detects the RFID device 115, and the direction of motion. In these embodiments, the signals from the RFID reader 220 indicate how a target has crossed a passage node. For example, the identity of the RFID reader 220 and/or antenna 210 can demonstrate that a target has moved across a passage node between Room A and Hallway B. The direction of motion can indicate whether the target has moved from the room to the hallway, or vice versa. The central server 105 can update the location of the target accordingly.

In further embodiments, the central server 105 does not store any locations at all. The locations of the RFID reader 220 and/or the antennae 210 can be locally stored at the motion processing module 200. When the RFID reader 220 transmits the identifying information of detected RFID devices 115, the RFID reader 220 can also transmit the reader's 220 or antenna's 210 location. The central server 105 can update the location of the target according to the location received from the RFID reader 220.

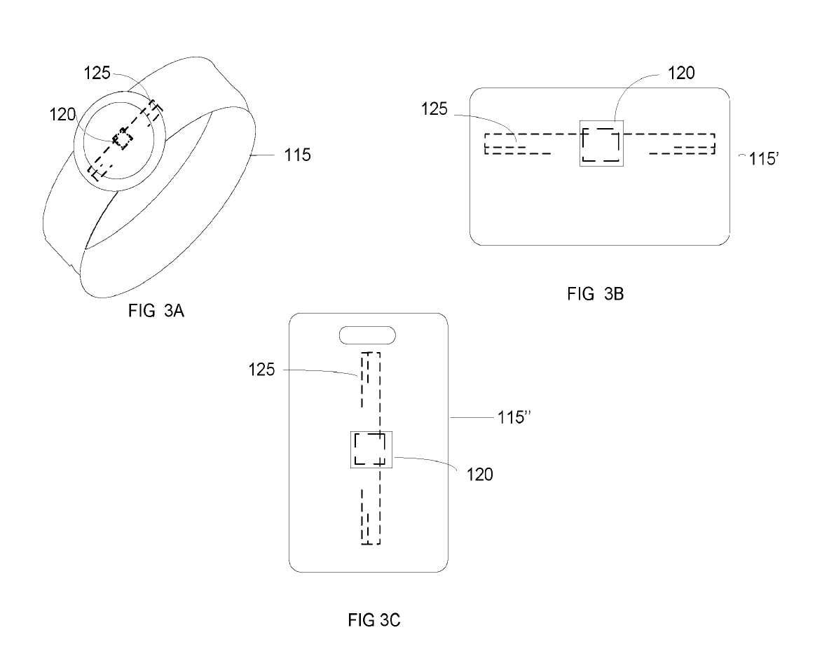

Referring now to FIGS. 3A-3C, the RFID device 115 can include an RFID tag 120 (also referred to herein as a “tag chip”) and an antenna 125. Each RFID device 115 can be pre-recorded with identifying information, such as a serial number, on the tag chip 120. The identifying information can be pre-recorded in the tag chip 120 during manufacture. The RFID device 115 can take the form of a wristband (FIG. 3A), a card (FIG. 3B), a badge (FIG. 3C), or any other form as would be evident to one of ordinary skill in the art. In some embodiments, the RFID device 115 is a passive ultra-high frequency (UHF) RFID device.

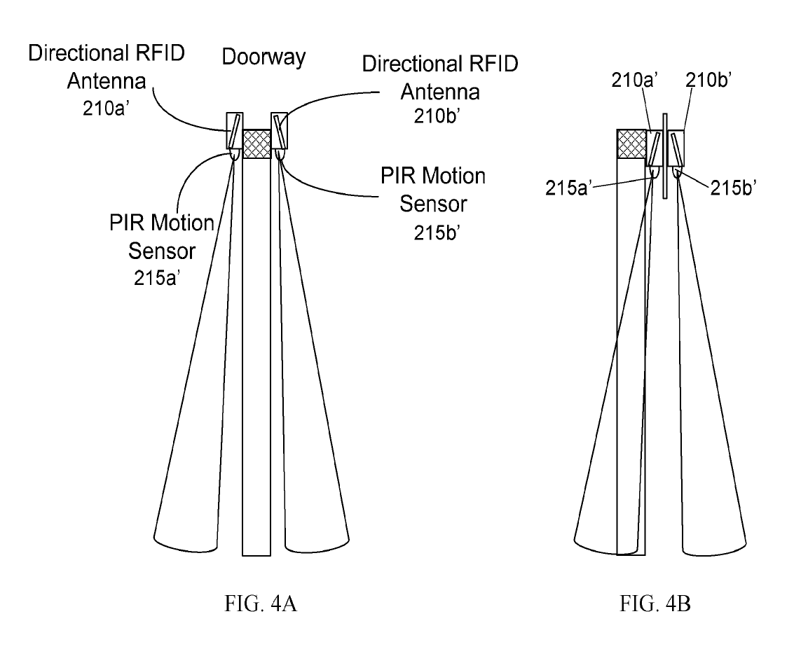

Referring now to FIGS. 4A and 4B, two possible installations of a motion processing module 200 over a doorway are shown and described. The motion processing modules 200 in these examples have two sets of directional antennae 210′ and PIR motion sensors 215′, each set including an antenna 210′ and a motion sensor 215′. In FIG. 4A, the sets of antennae 210′ and motion sensors are placed on opposite sides of the doorway. In FIG. 4B, both sets are placed on the same side of the doorway. When a target moves through the doorway, the motion sensors 215′ can detect the motion and the motion detector 205 can determine which direction the target is moving by, for example, analyzing the order in which the motion sensors 215′ detect motion. Based on the direction of motion, the motion detector 205 can select the antenna 210′ that should be powered to detect RFID devices 115. The selected antenna 210′ can detect identifying information of RFID devices 115 for transmission to the central server 105. The central server 105 can update the location of the device's 115 target, according to any of the methods described in reference to FIG. 2.

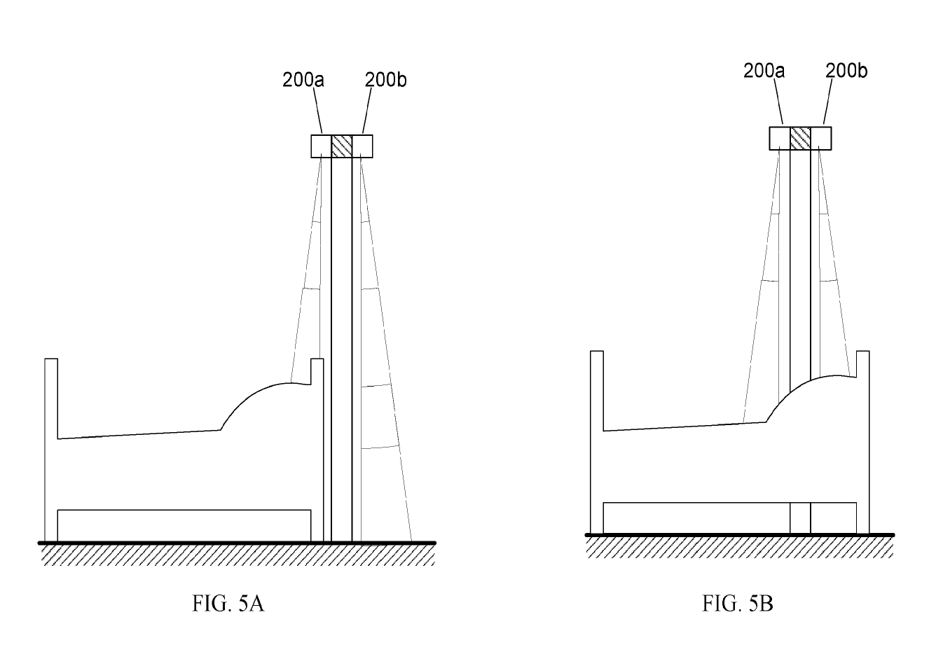

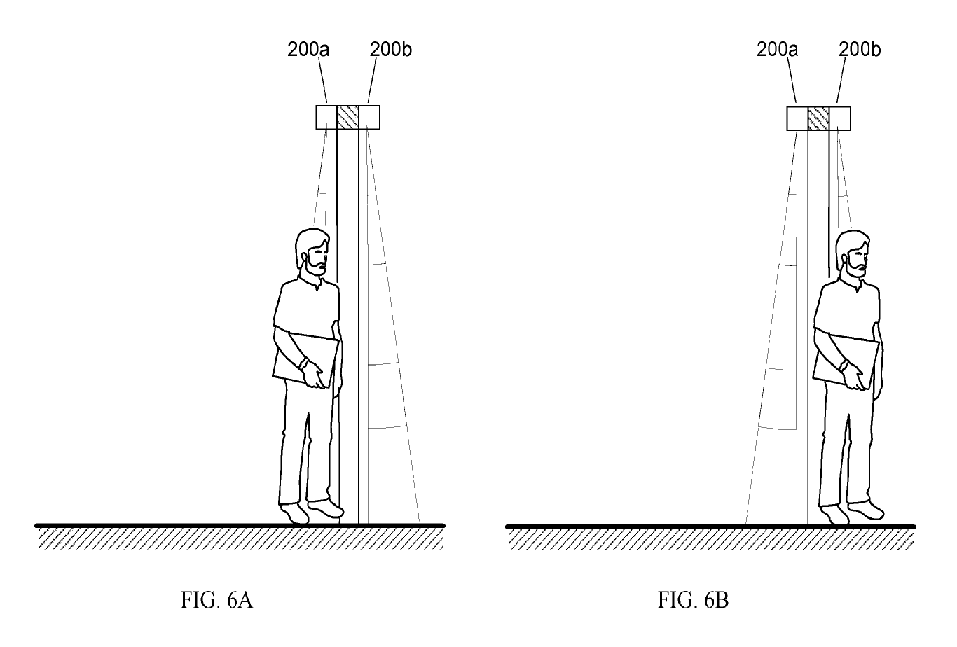

Referring now to FIGS. 5A, 5B, 6A, and 6B, detection of a target passing through a motion processing module 200 installed over a doorway, as in FIG. 4A, is shown and described. In FIGS. 5A and 5B, the target is a bed. In FIGS. 6A and 6B, the target is a person. In these figures, one motion sensor 215 detects the presence of the target before the other motion sensor 215 of the motion processing module 200. The motion detector 205 can select the antenna 210 that detects the identifying information of the target's RFID device 115. The RFID reader 220 can transmit the identifying information to the central server 105. The RFID reader 220 can also transmit the direction of motion, and the central server 105 can update the location of the target, according to any of the methods described in reference to FIGS. 2, 4A, and 4B.

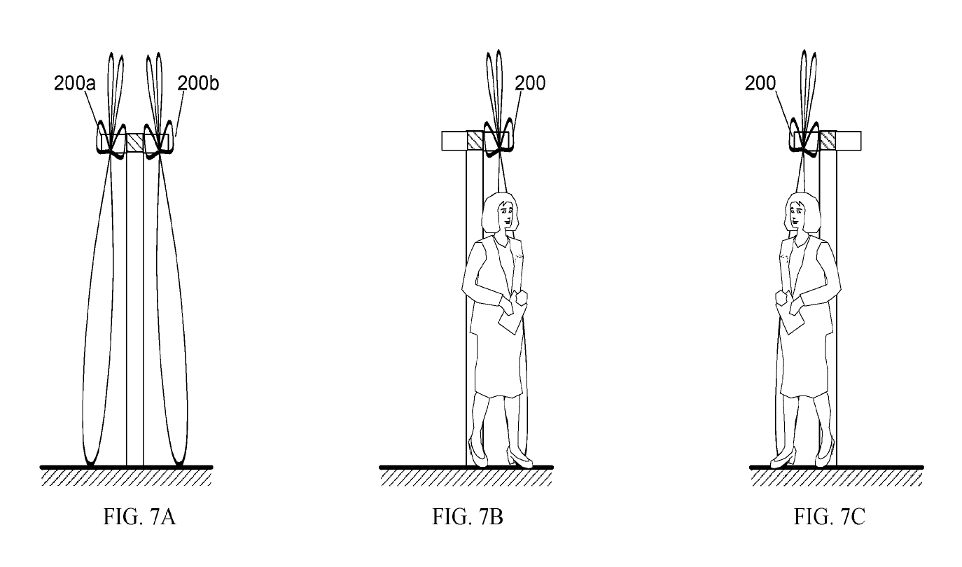

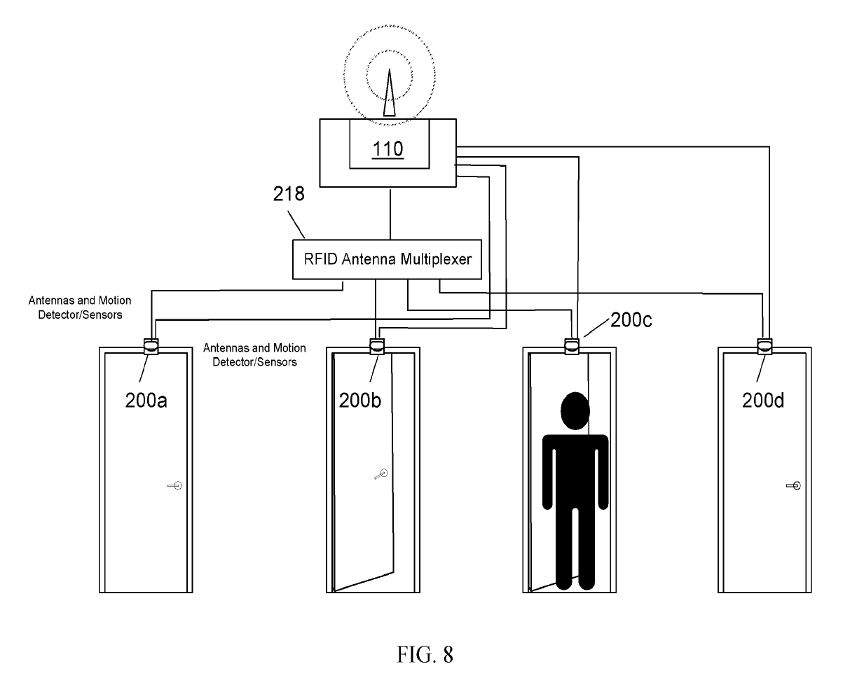

Referring now to FIG. 7A, another possible installation of a motion processing module 200 over a doorway, as in FIG. 4A, is shown.

Referring now to FIGS. 7B and 7C, two possible installations of a motion processing module 200 over a doorway, as in FIG. 4B, are shown and described. In these figures, the target is a person. The motion processing module 200 can detect RFID devices 115 of targets according to any of the methods described in reference to FIGS. 4 through 6B.

Referring now to FIG. 7, installation of a tracking module 110 to span multiple locations is shown and described. The motion processing modules 200a, 200b, 200c, 200d of the tracking module 110 are installed over multiple doorways. Each motion processing module 200 includes motion sensors 215, a motion detector 205, and antennae 210 positioned proximate to the doorway. The motion processing modules 200 communicate with the same RFID reader 220 via the RFID antenna multiplexer 218. According to detected motion from the motion processing modules 200, the RFID reader 220 powers various antennae 210 within the tracking module 110 to detect RFID devices 115. Then, the RFID reader 220 receives identifying information of RFID devices 115 from the motion processing modules 200 and transmits such information to the central server 105.

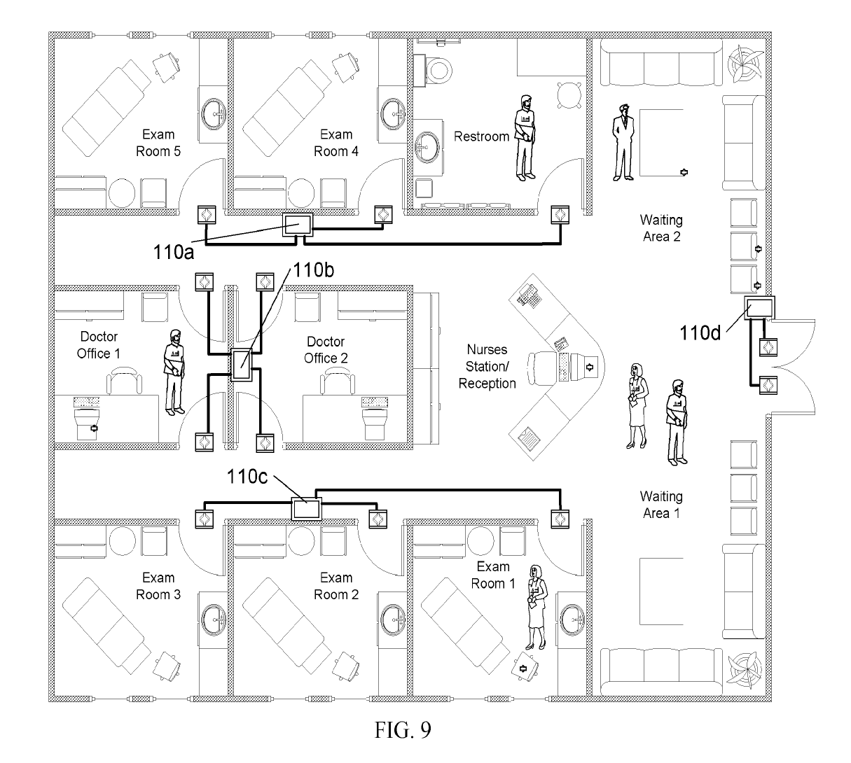

Referring now to FIG. 9, installation of tracking modules 110 in a hospital is shown and described. In this particular example, the asset and personnel tracking system of FIG. 9 includes four tracking modules 110a, 110b, 110c, 110d each spanning multiple locations. One tracking module 110a includes three motion processing modules 200 to detect movement of targets between Exam Room 4, Exam Room 5, and the Restroom relative to a hallway. Another tracking module 110b includes four motion processing modules 200 to detect movement of targets between Doctor Office 1 and Doctor Office 2 relative to two hallways. A third tracking module 110c includes three motion processing modules 200 to detect movement of targets between Exam Room 1, Exam Room 2, and Exam Room 3 relative to a hallway. The last tracking modules 110 includes two motion processing modules 200 to detect movement of targets entering and exiting the hospital.

While the invention has been particularly shown and described with reference to specific embodiments, it should be understood by those skilled in the art that various changes in form and detail may be made therein without departing from the spirit and scope of the invention as defined by the appended claims.

What is claimed:

1. A tracking system for updating a location of a target associated with an RFID device in response to detected motion of the target, the system comprising:
a server for storing identifying information for at least one RFID device and a location associated with the RFID device; and
a plurality of tracking modules positioned in predetermined locations and in communication with the server, each tracking module comprising at least one motion processing module and an RFID reader,
wherein, in response to motion detected by the at least one motion processing module, the RFID reader detects identifying information associated with the RFID device neighboring the RFID reader and transmits the detected identifying information to the server.

2. The system of claim 1, wherein the identifying information is a serial number associated with the RFID device.

3. The system of claim 1, wherein the server updates the location associated with the RFID device according to an identity of the RFID reader that transmits the detected identifying information.

4. The system of claim 1, wherein the RFID reader transmits a location of the RFID reader to the server in conjunction with the detected identifying information of the RFID device.

5. The system of claim 1, wherein a target is an asset or a person.

6. The system of claim 1, wherein each motion processing module comprises at least two directional motion sensors and a motion detector, the motion detector analyzing signals received from the at least two directional motion sensors to select at least one directional RFID antenna for detecting the neighboring RFID devices.

7. The system of claim 6, wherein the motion detector determines a direction and a distance of motion from the received signals and selects the directional RFID antenna for detecting the neighboring RFID devices according to the direction and the distance.

8. The system of claim 7, wherein the RFID reader uses the determined direction and distance of motion to use at least one particular directional RFID antenna.

9. The system of claim 1, wherein the RFID reader comprises a microcontroller in communication with the at least one motion processing module, the microcontroller initiating detection of the identifying information by the RFID reader in response to motion detected by the at least one motion processing module.

10. The system of claim 1, wherein the RFID device is at least one of a wristband, a badge, and a card.

11. The system of claim 1, wherein the server updates the location associated with the RFID device in response to transmitted identifying information associated with the RFID device.

12. A method for updating a location of a target associated with an RFID device in response to detected motion of the target, the method comprising:
detecting, by a motion processing module of an RFID reader, motion;
detecting, by the RFID reader in response to the motion, identifying information associated with an RFID device neighboring the RFID reader;
transmitting, by the RFID reader, the identifying information to the server; and
updating, by the server, a location of the RFID device according to the identifying information of the RFID device and an identity of the RFID reader.

13. The method of claim 12, further comprising transmitting, by the RFID reader, a location of the neighboring RFID reader to the server.

14. The method of claim 12, wherein detecting motion further comprises analyzing, by a motion detector of the motion processing module, signals received from at least two directional motion sensors.

15. The method of claim 14, wherein detecting motion further comprises selecting, by the motion detector, at least one directional RFID antenna for detecting the neighboring RFID device.

16. The method of claim 14, wherein detecting motion further comprises
determining, by the motion detector, a direction and a distance of motion from the received signals; and
selecting, by the RFID reader, a directional RFID antenna for detecting the neighboring RFID device according to the direction and the distance.
